(19) United States
(12) Patent Application Publication
(10) Pub. No.: US 2003/0019959 A1
(43) Pub. Date: Jan. 30, 2003

(54) Fuel injection device for internal combustion engines

(76) Inventors: Achim Brenk, Kaempfelbach-Bilfingen (DE); Wolfgang Klenk, Loechgau (DE); Uwe Gordon, Markgroeningen (DE); Manfred Mack, Altheim (DE); Marcus Parche, Croix Pivort (FR)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/111,288

(22) PCT Filed: Jun. 27, 2001
(86) PCT No.: PCT/DE01/02846

(30) Foreign Application Priority Data
Aug. 22, 2000 (DE) 10041024.3

(51) Int. Cl. B05B 1/30

(52) U.S. Cl. 239/585.5; 239/585.4; 239/585.1; 239/533.9

(57) ABSTRACT

In a fuel injection system for internal combustion engines, having two control valves (15, 34), provided for controlling the injection event, whose valve bodies each have one magnetically attractable armature (41, 45), and having a common magnet coil (40) for the two armatures (41, 45), in a first current stage of the common magnet coil (40), only one armature (41), and in a higher second current stage both armatures (41, 45), are each attractable counter to the action of a closing force. Thus with only a single magnet drive mechanism, two valve functions can be switched via two exciter currents of different magnitudes.

### PRIOR ART

The invention is based on a fuel injection system as generically defined by the preamble to claim 1. In one such fuel injection system, known from German Patent Disclosure DE 195 17 578 A1, two control valves are actuated by means of a common electromagnet, into whose magnetic circuit the two armatures of the control valves dip from opposed sides. Supplying current to the electromagnet causes the two armatures to be pulled further into the electromagnet, counter to the action of a closing spring disposed between them, and thus the two control valves are opened synchronously.

Although with the known fuel injection system a compact design and thus a unit that on the one hand saves space and on the other can be produced substantially less expensively have been made possible for two control valves, nevertheless this unit is usable only for the synchronous opening and closing of the two control valves.

### ADVANTAGES OF THE INVENTION

The fuel injection system of the invention for internal combustion engines, having the definitive characteristics of claim 1, has the advantage over the prior art that with only one magnet drive mechanism, via two exciter currents of different magnitudes, two valve functions can be controlled. This has advantages in terms of installation space, cost, expense for control equipment, and the line system.

For example, one control valve can be used for controlling the fuel injection (that is, for metering the fuel), and the other control valve can be used for controlling the injection cross section. Compared to other known systems, this system offers the possibility of control by magnet valve technology with only a single electromagnet. In conjunction with various pressure-controlled opening mechanisms for the valve body and various hydraulically controlled stroke stops or tandem or coaxial nozzle configurations, the timing of the injection and the switchover between two different injection cross sections can thus be achieved freely in the engine performance graph.

Further advantages and advantageous features of the subject of the invention can be learned from the description, drawing and claims.

### DRAWING

Two exemplary embodiments of the fuel injection system of the invention for internal combustion engines are shown in the drawing and will be described in further detail in the ensuing description. Shown are:

FIG. 1, a first exemplary embodiment of a fuel injection system, having an injection valve that has two schematically shown control valves for controlling the fuel injection and the injection cross section;

FIG. 2, the two control valves of FIG. 1 in a more-detailed fragmentary view, the two control valves being actuatable via a common magnet drive mechanism;

FIG. 3, a modification of the second control valve, in a view analogous to FIG. 2; and

FIG. 4, a second exemplary embodiment of a fuel injection system, analogous to the view in FIG. 1, with a modified injection valve that has two schematically shown control valves for controlling the fuel injection and the injection cross section.

### DESCRIPTION OF THE EXEMPLARY EMBODIMENTS

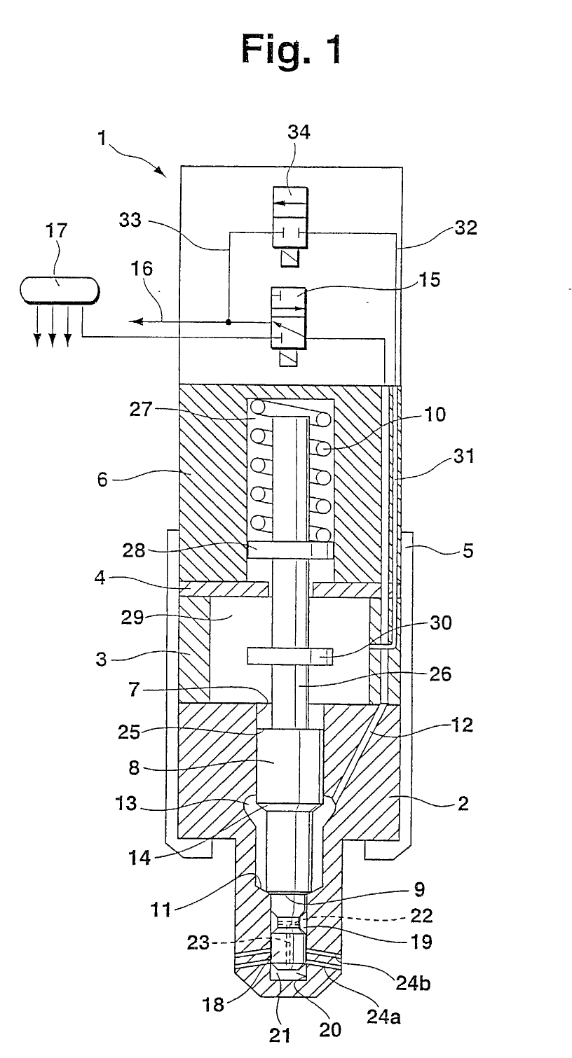

The first exemplary embodiment, shown in FIG. 1, of a fuel injection system for internal combustion engines has an injection valve 1 with a nozzle body 2, which together with a sleeve 3 and a shim 4 is firmly fastened by a union nut 5 to a nozzle holder 6. In an axial guide bore 7 of the nozzle body 2, a pistonlike valve body 8 in the form a nozzle needle is displaceably supported; its valve sealing face 9 is pressed by a closing spring 10, disposed in the nozzle holder 6, against a conical valve seat face 11. Extending in the injection valve 8 is a pressure line 12, which discharges into an annular pressure chamber 13 in the nozzle body 2. In the region of the pressure chamber 13, the valve body 8 has a pressure shoulder 14, which is engaged in the direction of opening at the valve body 8 by the fuel delivered via the pressure line 12. Via a first control valve 15, embodied as a 3/2-way valve, the pressure line 12 can be made to communicate with either a relief line (leak fuel) 16 or a high-pressure reservoir (common rail) 17 for the fuel.

From the valve seat face 11, an annular gap (not shown) between the head portion 18 of the valve body 8 remote from the nozzle holder 6 and the bore wall of the nozzle body 2 to an annular chamber 19, which is formed by an annular groove provided on the head portion 18. The head portion 18 is guided in a blind bore 20, whose bottom chamber 21 communicates with the annular chamber 19 via transverse and longitudinal bores 22, 23 provided in the head portion 18. In the position shown in FIG. 1, the head portion 18 closes two injection conduits 24a, 24b that originate at the blind bore 20 and discharge into the combustion chamber of the engine to be supplied.

On the side remote from the head portion 18, the valve body 8 has an annular shoulder 25 at the transition to a shaft 26, which shaft extends through a bore in the shim 4 and into a spring chamber 27. There, the shaft 26 has a spring plate 28, which is engaged by the closing spring 10 braced on its other end in the spring chamber 27.

The stroke executed by the valve body 8 upon opening is controlled by a limitation device, in the form of a low-pressure stroke stop (not shown), which is provided in the interior 29 of the sleeve 3 and cooperates for instance with a further plate 30 of the shaft 26. The interior 29 can be made to communicate with the relief line 16 via lines 31, 32, 33 and via a second control valve 34 embodied as a 2/2-way valve. When the second control valve 34 is closed, the low-pressure stroke stop has the effect that the fuel located in the interior 29 is compressed upon opening of the valve body 8. As a result, the opening stroke of the valve body 8 is hydraulically limited in such a way that only the lower injection conduit 24a is opened by the head portion 18 for an injection. When the second control valve 34 is opened, the fuel located in the interior 29 is not compressed but instead flows out via the relief line 16, so that no stroke limitation takes place. Consequently, the valve body 8 executes its maximum stroke, so that the head portion 18 opens both injection conduits 24a, 24b, or in other words uncovers a larger injection cross section.

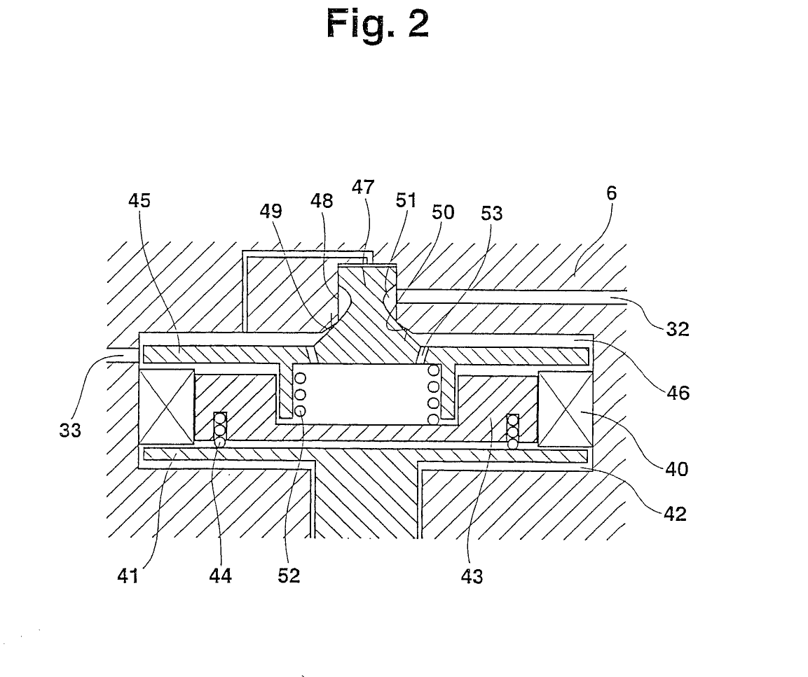

FIG. 2, in an enlarged sectional view, shows the internal structure of the two control valves 15, 34, which have a common magnet drive mechanism in the form of a magnet coil 40. A platelike first armature 41, which is connected to the valve body (not shown) of the first control valve 15, is guided axially displaceably in a first armature chamber 42 of the nozzle holder 6, and is prestressed by a first closing spring 44 braced on a separator element 43 into its valve position (FIG. 1) that opens the communication between the pressure line 12 and the relief line 16, cooperates with the magnet coil 40.

On the side of the magnet coil 40 opposite the first armature 41, a platelike second armature 45 cooperates with the magnet coil 40; it is guided axially displaceably in a second armature chamber 46 of the nozzle holder 6 and simultaneously forms the valve body of the second control valve 34. The second armature 45, with an extension 47, engages a bore 48 in the nozzle holder 6, and at the transition to the extension 47, it has a valve sealing face 49, which cooperates with a conical valve seat face 50 at the bore 48. The inlet line 32 of the second control valve 34 discharges into the bore 48 in the region of a chamber 51 embodied on the extension 47. By means of a second closing spring 52, braced on the separator element 43, the second armature 45 is prestressed into its valve position that blocks the communication between the inlet line 32 and the outlet line 33 that leads away from the second armature chamber 46. In the second armature 45, connecting conduits 53 are provided, so that the second armature 45 is in force equilibrium. By means of the separator element 43, the armature chambers 42, 46 and thus the two control valves 15, 34 are separated from one another. The two closing springs 44, 52 are designed such that in a first current stage of the magnet coil 40, only the first armature 41 is attracted, and in a second, higher current stage both armatures 41, 45 are attracted. In the exemplary embodiment shown, the two armatures 41, 45 are attracted in opposite directions, but in other versions the two armatures can also be attracted in the same direction. The two armatures 41, 45 can be embodied as flat armatures or as plunger armatures.

The fuel injection system shown in FIGS. 1 and 2 functions as follows. When current is supplied to the magnet coil 40 at the first or second current stage, the first armature 41 is attracted and the first control valve 15 is actuated as a result, so that the pressure line 12 communicates with the high-pressure reservoir 17, and the fuel injection ensues. In the first current stage, the second armature 45 is not attracted; that is, the second control valve 34 remains closed. As a result, a pressure rise occurs in the interior 29 and also in the chamber 51, resulting in a stroke limitation, so that the injection takes place at the smaller injection cross section. In the second current stage, not only the first armature 41 but simultaneously the second armature 45 is attracted; that is, the second control valve 34 is opened. The fuel positively displaced in the opening stroke of the valve body 8 can flow out into the relief line 16 via the lines 31, 32, the second armature chamber 46, and the line 33. As a result, a pressure rise does not occur in the interior 29 and in the chamber 51, and accordingly there is no stroke limitation, so that the injection takes place at the larger injection cross section.

These two states in the interior 29 and in the chamber 51, that is, the pressureless state and the state subjected to pressure, are employed to control the injection cross section; this control can be used with hydraulic stroke stops or with a switchover between different valve bodies (nozzle needles) in the case of tandem or coaxial injectors.

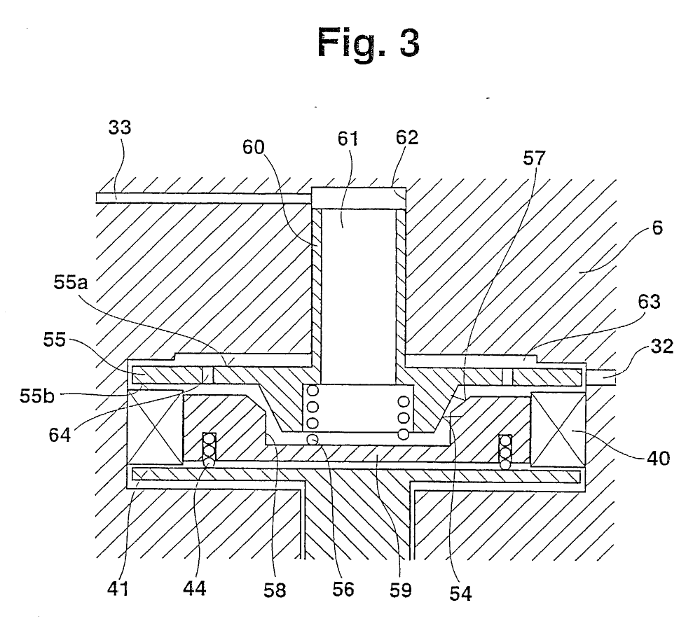

FIG. 3, in an enlarged sectional view, shows a different internal structure of the second control valve 34. The valve sealing face 54 of the second armature 55 is provided on the underside, pointing toward the first armature 41, of the second armature and is prestressed by the second closing spring 56 away from a conical valve seat face 57 at a bore 58 in the separator element 59. By means of a central through bore 61 that also passes through the extension 60, the bore 58 communicates with the bore 62, from which the outlet line 33 leads away. The sealing seat between the valve sealing face 54 and valve seat face 57 blocks the communication between the bore 58 and the second armature chamber 63, into which the inlet line 32 discharges. Connecting conduits 64 are provided in the second armature 55, so that the second armature 55 is in force equilibrium when the sealing seat is open. The two armatures 41, 45 can be embodied as flat armatures or plunger armatures.

When electric current is supplied to the magnet coil 40 at the first or second current stage, the first armature 41 is attracted and as a result the first control valve 15 is actuated, so that the pressure line 12 is in communication with the high-pressure reservoir 17, and the fuel injection ensues. At the first current stage, the second armature 55 is not attracted; that is, the second control valve 34 remains open. The fuel positively displaced in the opening stroke of the valve body 8 can flow out into the relief line 16 via lines 31, 32, the second armature chamber 63, the bore 58, the through bore 61, the bore 62, and the line 33. As a result, there is no pressure rise in the interior 29 and in the second armature chamber 63, so there is no stroke limitation and thus the injection takes place at the larger injection cross section. At the second current stage, not only the first armature 41 but simultaneously the second armature 55 is also attracted; that is, the second control valve 34 is closed. As a result, a pressure rise in the interior 29 and thus a stroke limitation occur, so that the injection takes place at the smaller injection cross section.

When the second armature 55 is attracted, that is, the sealing seat between the valve sealing face 54 and the valve seat face 57 is closed, the underside 55b subjected to the pressure prevailing in the armature chamber 63 is smaller, by the surface area defined by the valve seat 57, than the top side 55a, so that the second armature 55 is no longer in force equilibrium but instead is subjected additionally to force in the closing direction by the pressure prevailing in the armature chamber 63. Because of this self-holding of the attracted second armature 55, a lesser current in the magnet coil 40, once the second armature 55 has been attracted for the first time, suffices to keep the second armature 55 in its closing position. After the attraction of the second armature 55, the current in the magnet coil 40 can therefore be reduced, and thus the current consumption of the injection valve 1 can be lowered.

These two states in the interior 29 and in the second armature chamber 63, that is, the pressureless state and the state subjected to pressure, are employed to control the injection cross section; this control can be used with hydraulic stroke stops or with a switchover between different valve bodies (nozzle needles) in the case of tandem or coaxial injectors.

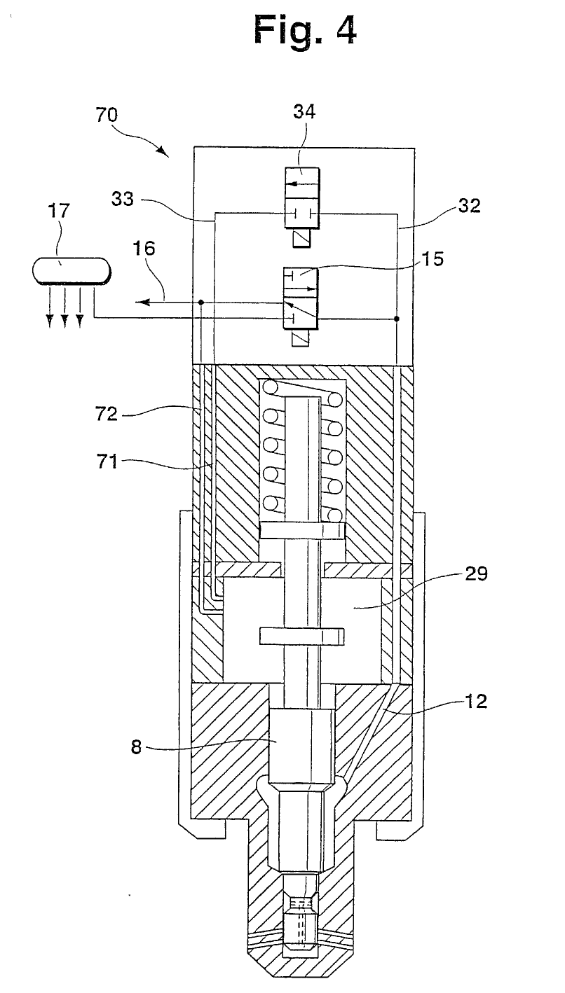

In FIG. 4, a second exemplary embodiment of a fuel injection system with a modified injection valve 70 is shown, in which the line 71 discharging into the interior 29 can be made to communicate with the pressure line 12 via the lines 32, 33 and the second control valve 34. From the interior 29, a line 72 leads away, discharging into the relief line 16. The two control valves 15, 34 are embodied as shown in FIG. 2 or FIG. 3. A stroke stop (not shown) is provided in the interior 29 and hydraulically limits the opening stroke of the valve body 8 if an overpressure prevails in the interior 29.

The fuel injection system shown in FIG. 4 functions as follows. By actuation of the first control valve 15, the pressure line 12 is made to communicate with the high-pressure reservoir 17, so that the fuel injection ensues. When the second control valve 34 is closed (that is, at the first current stage of the magnet coil 40), the lines 33, 71 do not communicate with the line 32 connected to the pressure line 12, and thus the interior 29 is not subjected to high pressure. The fuel positively displaced out of the interior 29 in the opening stroke of the valve body 8 flows out to the relief line 16 via the line 72, so that in the interior 29 no pressure rise occurs, and thus there is no stroke limitation. Conversely, when the second control valve 34 is open (that is, at second current stage of the magnet coil 40), the lines 33, 71 communicate with the pressure line 12 via the line 32, and thus the interior 29 is subjected to high pressure, so that the opening stroke of the valve body 8 is limited by the stroke stop (not shown) provided in the interior 29.

These two states in the interior 29, that is, the pressureless state and the state subjected to pressure, are employed to control the injection cross section; this control can be used with hydraulic stroke stops or with a switchover between different valve bodies (nozzle needles) in the case of tandem or coaxial injectors.

The injection valves 1, 70 shown in FIGS. 1 and 4 have so-called “I-nozzles”, in which the opening stroke of the valve closing body 8 takes place in the direction of the inside of the nozzle body 2. The invention is not limited to this type of nozzle. In other embodiments, not shown, the invention is provided in so-called “A-nozzles”, in which the opening stroke of the valve closing body 8 is effected in the direction out of the nozzle body 2.

In a fuel injection system for internal combustion engines, having two control valves 15, 34, provided for controlling the injection event, whose valve bodies each have one magnetically attractable armature 41, 45, and having a common magnet coil 40 for the two armatures 41, 45, in a first current stage of the common magnet coil 40, only one armature 41, and in a higher second current stage both armatures 41, 45, are each attractable counter to the action of a closing force. Thus with only a single magnet drive mechanism, two valve functions can be switched via two exciter currents of different magnitudes.

1. A fuel injection system for internal combustion engines, having two control valves (15, 34), provided for controlling the injection event, whose valve bodies each have one magnetically attractable armature (41, 45, 55), and having a common magnet coil (40) for the two armatures (41, 45, 55), characterized by a first current stage of the common magnet coil (40), in which only one armature (41) is attracted counter to the action of a closing force, and by a higher second current stage, in which both armatures (41, 45, 55) are each attracted counter to the action of a closing force.

2. The fuel injection system of claim 1, characterized in that the closing force, acting on the armature (45, 55) that is attracted only in the second current stage is greater than the closing force acting on the other armature (41).

3. The fuel injection system of claim 1 or 2, characterized in that the common magnet coil (40) attracts the two armatures (41, 45, 55) in opposite directions.

4. The fuel injection system of one of the foregoing claims, characterized in that the two control valves (15, 34) are separated from one another by a separator element (43, 59) secured between their armatures (41, 45, 55).

5. The fuel injection system of claim 4, characterized in that each armature (41, 45, 55) is assigned a closing spring (44, 52, 56), both of which are braced on the separator element (43, 59).

6. The fuel injection system of claim 4 or 5, characterized in that the valve sealing face (49, 54) of a control valve (34) is provided on the armature (45, 55).

7. The fuel injection system of claim 6, characterized in that the valve seat face (50, 57) cooperating with the valve sealing face (49, 54) is provided on a bore (48, 58) of the valve housing (6) or of the separator element (59).

8. The fuel injection system of claim 7, characterized in that the inlet line (32) of one control valve (34) discharges into the bore (48) of the valve housing (6), and the outlet line (33) branches off from an armature chamber (46) of the armature (45).

9. The fuel injection system of claim 7, characterized in that the armature (55) has a through bore (60), connecting the bore (58) of the separator element (59) to the outlet line (33), and the inlet line (32) discharges into an armature chamber (63) of the armature (55).

10. The fuel injection system of one of the foregoing claims, characterized in that when the sealing seat between the valve seat face (57) and the valve sealing face (54) of the armature (55) is closed, the surface area of the armature (55) exposed to the fuel pressure in the closing direction of the associated valve body is larger than its surface area exposed to the fuel pressure in the opening direction.

11. The fuel injection system of one of the foregoing claims, characterized in that at least one armature (41, 45) is attractable in the opening direction of its assigned valve body by the magnet coil (40).

12. The fuel injection system of one of the foregoing claims, characterized in that at least one armature (55) is attractable in the closing direction of its assigned valve body by the magnet coil (40).

13. The fuel injection system of one of the foregoing claims, characterized in that the two control valves (15, 34) are provided in one injection valve (1, 70).

14. The fuel injection system of one of the foregoing claims, characterized in that via one control valve (15), the pressure chamber (13) of an injection valve (1, 70), which in particular is pressure-controlled, is connectable to a high-pressure source for the fuel.

15. The fuel injection system of one of the foregoing claims, characterized in that via one control valve (34) in an injection valve (1, 70), which in particular is pressure-controlled, a limitation device for the opening stroke is hydraulically triggerable.

16. The fuel injection system of claim 15, characterized in that for a stroke limitation, the communication between an interior (29) of the limitation device, subjected to overpressure upon opening of the injection valve (1, 70), and a relief line (16) is blockable by means of the control valve (34).

17. The fuel injection system of claim 15, characterized in that for a stroke limitation, an interior (29) of the limitation device is connectable to the high-pressure source by means of the control valve (34).
